(19) United States
(12) Patent Application Publication
(10) Pub. No.: US 2021/0176520 A1
(43) Pub. Date: Jun. 10, 2021

(54) SYSTEMS AND METHODS FOR MEDIA STORAGE AND RETRIEVAL

(71) Applicants: Gary DeWitt, Everett, WA (US); Terry Ann DeWitt, Everett, WA (US)

(72) Inventors: Gary DeWitt, Everett, WA (US); Terry Ann DeWitt, Everett, WA (US)

(21) Appl. No.: 15/734,396

(22) PCT Filed: Jun. 6, 2019
(86) PCT No.: PCT/US19/35763

§ 371 Date: Dec. 2, 2020

Related U.S. Application Data
(60) Provisional application No. 62/682,580, filed on Jun. 8, 2018.

(51) Int. Cl. H04N 21/432; H04N 21/433; G11B 27/00; H04N 21/426; H04N 21/4363; G11B 7/005; G06F 16/43

(52) U.S. Cl. CPC H04N 21/4325; H04N 21/433; G11B 27/002; G06F 16/43; H04N 21/43637; G11B 7/005; H04N 21/42646

(57) ABSTRACT

Systems and methods for media storage and retrieval. In one embodiment, a system may include a controller to receive first commands from a remote control, transmit second commands to a mass storage device, receive first signals corresponding to data from the mass storage device, and transmit second signals corresponding to the first signals to a display device or audio device configured to receive the second signals and reproduce the data for observation by a user. The mass storage device may include a mechanism to store, retrieve, and play one or more discs containing the data, and it may be configured to transmit the data to the controller using the first signals. Methods for media storage and retrieval are also disclosed herein.

### CROSS-REFERENCE TO RELATED APPLICATION

The present application claims priority to U.S. Provisional patent Application No. 62/682,580, filed Jun. 8, 2018, which is incorporated herein in its entirety by reference.

### BACKGROUND

Despite the growing popularity of streaming media and digital downloads, many consumers continue to maintain and use physical media, such as compact discs (CDs), digital video discs (DVDs), Blu-ray discs, or other types of optical discs, and even cassette tapes such as audio cassettes and Video Home System (VHS) cassettes. Some consumers may have sizeable collections of physical media in addition to collections of virtual media, such as MP3 files, MPEG files, or other audio or video files in electronic format.

One problem with having large quantities of physical media is difficulty with storage and retrieval for use. For example, some consumers may have disorganized stacks of video and audio discs in a large collection shared among a household, perhaps scattered around different rooms and vehicles. And some consumers may only have a limited number of players capable of reading the media, while those players may be scattered around different locations. For example, a user may have a DVD player in the family room, a CD player in the office, and a video game system in the basement. Accordingly, it may be frustrating for some users to locate a desired movie, musical recording, video game, or other media for play in various locations. When a consumer loads, unloads, or otherwise handles the physical media, there is a risk that the media will be damaged, sometimes to the point of being unreadable.

### BRIEF DESCRIPTION OF THE DRAWINGS

Many aspects of the present disclosure can be better understood with reference to the following drawings. The components in the drawings are not necessarily to scale. Instead, emphasis is placed on clearly illustrating the principles of the present disclosure.

FIG. 1 illustrates a schematic view of a media storage and retrieval system configured in accordance with an embodiment of the present technology.

FIG. 2 illustrates a flow diagram of a media storage and retrieval process in accordance with an embodiment of the present technology.

FIG. 3 illustrates a flow diagram of a media storage and retrieval process in accordance with another embodiment of the present technology.

FIG. 4 illustrates a schematic view of a media storage and retrieval system configured in accordance with another embodiment of the present technology.

FIG. 5 illustrates a schematic view of a media storage and retrieval system configured in accordance with yet another embodiment of the present technology.

FIG. 6 illustrates a schematic view of a media storage and retrieval system with a carousel functioning as a fileserver for recordkeeping or records access configured in accordance with still another embodiment of the present technology.

FIG. 7 is a block diagram illustrating a representative architecture for a computer system or device that can be utilized to implement various portions of the present technology.

### DETAILED DESCRIPTION

The present technology is directed to systems and methods for media storage and retrieval. In one embodiment, for example, a system for media storage and retrieval may include a controller to receive first commands from a remote control, transmit second commands to a mass storage device, receive first signals corresponding to data from the mass storage device, and transmit second signals corresponding to the first signals to a display device or audio device configured to receive the second signals and reproduce the data for observation by a user. The mass storage device may include a mechanism to store, retrieve, and play one or more discs containing the data, and it may be configured to transmit the data to the controller using the first signals. A method for media storage and retrieval in accordance with the present technology may include receiving a media item, analyzing the media item to determine one or more pieces of information about the media item, storing the one or more pieces of information in a first database in a mass storage device, transmitting the first database to a controller, and creating, with the controller, a second database that includes the first database. The controller receives and responds to requests from a user to play the media item.

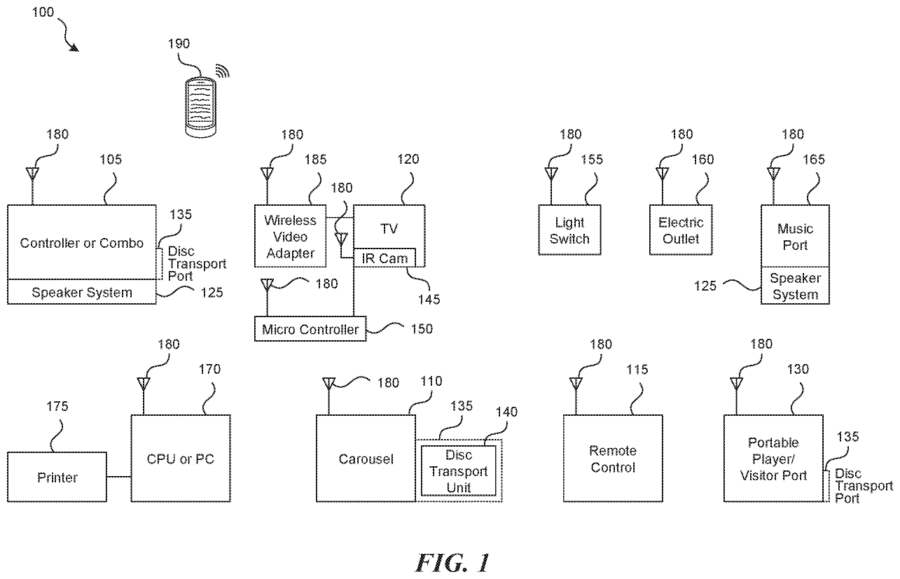

Various embodiments of the technology are described herein. The following description provides specific details for a thorough understanding and an enabling description of these embodiments. One skilled in the art will understand, however, that the technology may be practiced without many of these details. Additionally, some well-known structures or functions, such as those associated with wired and wireless networking, or reading and writing of physical or digital media, may not be shown or described in detail so as to avoid unnecessarily obscuring the relevant description of the various embodiments. Accordingly, the technology may include other embodiments with additional elements or without several of the elements described below with reference to FIGS. 1-6.

The terminology used in the description presented below is intended to be interpreted in its broadest reasonable manner, even though it is being used in conjunction with a detailed description of certain specific embodiments of the technology. Certain terms may even be emphasized below; however, any terminology intended to be interpreted in any restrictive manner will be overtly and specifically defined as such in this detailed description section.

Where the context permits, singular or plural terms may also include the plural or singular term, respectively. Moreover, unless the word “or” is expressly limited to mean only a single item exclusive from the other items in a list of two or more items, then the use of “or” in such a list is to be interpreted as including (a) any single item in the list, (b) all of the items in the list, or (c) any combination of items in the list. Further, unless otherwise specified, terms such as “attached” or “connected” are intended to include integral connections, as well as connections between physically separate components.

Specific details of several embodiments of the present technology are described herein with reference to discs, cassettes, hard drives, flash memory drives, and other various forms of media, in connection with entertainment or data storage. The technology may also be implemented in other applications, including, for example, recordkeeping, library services, or database management. The technology may be used to manage various forms of digital, analog, physical, or virtual media, including audio, video, documents, and other forms of media. Conventional aspects of some elements of the technology may be described in reduced detail herein for efficiency and to avoid obscuring the present disclosure of the technology.

Many embodiments of the technology described below may take the form of computer- or controller-executable instructions, including routines executed by a programmable computer or controller. Those skilled in the relevant art will appreciate that the technology can be practiced on computer/controller systems other than those shown and described below. The technology can be embodied in a special-purpose computer, controller or data processor that is specifically programmed, configured or constructed to perform one or more of the computer-executable instructions described below. Accordingly, the terms “computer” and “controller” as generally used herein refer to any data processor or data processing device and can include Internet appliances and hand-held devices (including palm-top computers, wearable computers, cellular or mobile phones, multi-processor systems, processor-based or programmable consumer electronics, network computers, mini computers and the like). Information handled by these computers can be presented at any suitable display medium, including a CRT display or LCD.

The technology can also be practiced in distributed environments, where tasks or modules are performed by remote processing devices that are linked through a communications network. In a distributed computing environment, program modules or subroutines may be located in local and remote memory storage devices. Aspects of the technology described below may be stored or distributed on computer-readable media, including magnetic or optically readable or removable computer disks, as well as distributed electronically over networks. Data structures and transmissions of data particular to aspects of the technology are also encompassed within the scope of the embodiments of the technology.

### A. MEDIA STORAGE AND RETRIEVAL SYSTEMS AND ASSOCIATED METHODS

Embodiments of the present technology store media, such as physical media or digital data, for access in various locations and by various devices. FIG. 1, for example, is a schematic view of a media storage and retrieval system 100 (“system 100”) configured in accordance with an embodiment of the present technology. A controller 105 (which may be nicknamed a “librarian”) provides centralized control of the system 100, including control of several optional devices. The controller 105 may take the form of a computer-controlled device with inputs, outputs, an optional screen or display, optional speakers or sound amplification equipment, and features suitable for networking with and controlling other devices of the system 100, which are described below. In some embodiments, the system 100 may include more than one controller 105, each of which may be networked with and may control other controllers or devices in the system 100. Controller(s) 105 may have built-in television tuners, cable or satellite transceivers, internet access devices, or other sources of media or data, including ports and slots for removable media.

The controller(s) 105 function as hubs to access and distribute media and data across the system 100. The controller(s) 105 may control operations of, and access to, the various other devices in the system 100, including televisions, media players, receivers for subscriber services such as cable or satellite entertainment, or other devices described herein. In general, controller 105 is connected to one or more televisions 120 or speaker systems 125 or similar devices to reproduce content (for example, display content and menus for operation, or produce audio output in the form of sound). The controller(s) 105 transmit commands to devices in the system 100 and receive signals from devices in the system 100 in the form of digital signals (such as data) or analog signals (such as audio or video signals). Controller(s) 105 may be in the form of a cabinet or self-contained unit, or they may form part of a stand or support for another device, such as a television.

A carousel 110 (which may be nicknamed a “stack”) may store various forms of media, including discs such as digital video discs (DVD), compact discs (CD), Blu-ray, or other types of discs or media, such as hard drives or flash memory, and it may have readers or players to read the types of media stored therein. In a particular embodiment, the carousel 110 may store 100, 250, 500, or any other suitable number of discs. In some embodiments, the carousel 110 may include card slots for receiving, reading, and writing non-volatile storage media, such as flash media. In various embodiments, the carousel 110 may store any suitable media or combinations of media. In some embodiments, the carousel 110 may have ports to interface with broadcast media, such as streaming media from the internet, cable television service, or satellite television service. In some embodiments, the carousel 110 may be integrated with the controller 105 as a combination device, or in other embodiments, it may be separate from the controller 105. The carousel 110 may contain, or function as, a database for the media stored or accessible therein.

In some embodiments, the carousel 110 may be loaded with media, such as discs, by a user inserting the media into a port or door in the carousel 110, or by a user inserting a disc transport unit 140 described below. For example, the carousel 110 may have a mechanism that retrieves and replaces a disc or other media from a disc transport unit 140. The carousel 110 may have a mechanism that retrieves and plays a selected disc from within its own storage mechanism. Although one carousel 110 is illustrated, the system 100 may include two or more, or any suitable number of carousels 110. Although the term “carousel” or “stack” may be used, such terms may be used herein to generally refer to mass storage devices configured to receive, store, and distribute media, for example, with a disc mechanism to receive, store, and play discs.

In some embodiments, the controller 105 maintains a record of capacity of the carousels 110. For example, the record may be in the form of a database or table that stores remaining capacity in each carousel 110. A user may access the storage record through menus provided by the controller 105 on a display.

A remote control 115 is a handheld or otherwise portable device with a user interface for navigating system 100 features or controlling system operations. There may be multiple remote controls 115 in the system 100, one or more of which may be master remotes with higher authority or control over devices in the system 100 relative to the other remote controls. The remote control 115 controls the controller 105, the carousel 110, or any other device associated with the system 100 (including components or devices described herein, or other components or devices), either through the controller 105 or directly.

The remote control 115 may include a video display or screen, or speakers or other audio output (such as a headphone jack or wireless signal output carrying audio data) to observe what is shown on a television 120, played in a speaker system 125, or shown on a portable player (described below). The video display or screen of the remote control 115 may also include a user interface with menus to control various features of the controller 105 or the other components in the system 100. In general, the video display of the remote control 115 duplicates or augments data shown on other screens or displays in the system 100. In some embodiments, a user may control a device in the system 100 (such as a television 120) using the remote control 115, while viewing menus or selections on the video display or screen of the remote control 115, without the menus or selections being shown on the device being controlled, to avoid indicating that the remote control 115 is controlling the device or to avoid interrupting the experience of a user viewing the device being controlled.

In some embodiments, the remote control 115 may be operable with voice commands. For example, the remote control 115 may include tables of speech translation data to listen with a microphone (which may be included in the remote control 115) and translate speech commands to usable commands in the system 100. For example, a user may say “play a song.” In response, the remote control 115 may invoke a menu of songs available in the carousel 110 or the controller 105. The menu may be displayed on the remote control 115 or on a display on another device, such as on the television 120. Upon selecting a song, a user may speak the song selection to begin playback. In some embodiments, voice recognition may be built into other devices in the system, such as the controller 105. In some embodiments, a Bluetooth® headset with a corresponding Bluetooth® receiver in a suitable device may be used for transmitting voice commands.

In some embodiments, the remote control 115 may communicate with devices (such as a television 120, DVD player, CD player, cable box, speaker system, or other devices) using universal standard codes. In some embodiments, universal standard codes are codes or protocols that enable devices made by different manufacturers or otherwise having their own command interface to pair with each other or to communicate with each other. For example, a remote control 115 may rely on the universal standard codes associated with DVD players to transmit controls of one or more of a plurality of DVD players. Likewise, the controller 105 may rely on the universal standard codes to communicate with other devices in the system 100.

In some embodiments, the remote control 115, working with the controller 105, can carry out complex activities in response to commands. For example, the remote control 115 may respond to a command to play a movie (entered by voice or by commands in the remote control 115 user interface) by instructing the television 120 and speaker system 125 to turn on, and by instructing the carousel 110 to retrieve and transmit the movie for playback on the television 120. In general, the remote control 115 receives commands from a user and transmits commands to the controller 105 or other devices in the system 100.

In some embodiments, the remote control 115 may be a small handheld device, or it may be a larger device such as a clamshell-style device approximately the size of a small laptop computer. It may include a keyboard, touch screen, or other user interface for entering commands and receiving and displaying feedback from devices of the system 100 or other external devices in response to those commands. It may be powered by a rechargeable or non-rechargeable battery, and it may have indicators to alert a user when battery power is low and a recharge is needed. It may disable itself (for example, power off) if it goes out of range. In some embodiments, the remote control 115 may have memory or memory card slots suitable for receiving flash memory, for example, to store media for viewing on the screen of the remote control 115. In some embodiments, the remote control 115 may have a locator feature, which may include a speaker for beeping when another device on the system 100 (such as controller 105) sends a ping for its location. In some embodiments, a remote control 115 may not be a dedicated or handheld device, such that instead it may be a larger device, such as a personal computer.

A portable player 130 (which may be nicknamed a “bookmobile”) may also be included in the system 100. The portable player 130 may include a screen or display and speakers or a wired or wireless port or jack for connecting to headphones or other external audio devices. The portable player 130 may include a disc player or other media reader for playback of media on the display or through the speakers. A user may take the portable player 130 anywhere for accessing media inside or outside of the home system 100. The portable player 130 may include a disc transport port 135 to receive a disc transport unit (nicknamed a “book”, and described in greater detail below) to receive discs or other media for playback. In some embodiments, the portable player 130 may receive or store media via internal memory or by a data connection with other devices in the system 100. In some embodiments, a portable player 130 may be controlled with the remote control 115.

In some embodiments, portable player 130 may function as a visitor port by connecting to the controller 105 or the carousel 110 and playing media through the controller 105 or carousel 110 without transferring media (such as media in disc transport units or books) into the host system. For example, a user may take the portable player 130 to another system to facilitate access to the media by the other system without giving the other system possession of the media. In some embodiments, the portable player 130 may be used for portable access to video or audio media, or for other types of media such as games or documents. Embodiments involving games or documents are described in additional detail below.

A disc transport unit 140 (which may be nicknamed a “book”) is a portable and modular container, such as a box, that stores media, such as discs. In some embodiments, the disc transport unit 140 may hold ten discs, twenty discs, or another suitable number of discs. For various media formats, disc transport units 140 may be a cartridge containing multiple media items, such as multiple discs or memory with virtual media. The disc transport unit 140 may be inserted into or otherwise connected to one or more of several components of the system 100. For example, it may be connected to the controller 105, the carousel 110, the portable player 130, or another device. Optionally, it may connect to devices via a disc transport port 135. The disc transport unit 140 may be loaded or unloaded by a mechanism or data connection in the carousel 110, such as the disc transport port 135. In some embodiments, the disc transport port 135 on the carousel 110 may be protected by mechanical doors.

One advantage and feature of the disc transport unit 140 is that a user may not need to directly or physically handle a disc very often. For example, a user may add the disc to the user's collection stored in the carousel 110 during an initial introduction of the disc to the system 100 (by loading the disc directly into the carousel). The carousel 110 may load the disc into the disc transport unit 140, which may be carried to other devices that can themselves retrieve the disc from the disc transport unit 140, such as the portable player 130 or disc transport port 135. Accordingly, the disc transport unit 140 may protect the discs from physical harm, such as scratching or loss. In some situations, after a user loads a disc into the carousel 110, the disc may never be directly touched by a user again until it is removed from the system 100 because it may be passed between various devices in the disc transport unit 140 and loaded into or unloaded from the disc transport unit 140 by the various devices in the system 100. In some embodiments, however, a user may manually insert or remove a disc or other media into or from the disc transport unit 140.

In some embodiments, disc transport units 140 may include an onboard memory, such as a flash memory, to hold a database. The database may include information about the discs, including the filename, title, author, content, number of plays or instances of access or other viewing history, parental control data, information about the host system with which the disc is associated, or other suitable data. For example, the disc transport units 140 may track a number of plays of a movie or song regardless of what device plays the movie. The disc transport unit 140 may communicate with devices to update its own data or to update the data when it returns to its home system 100. Because the disc transport unit 140 maintains its own database, a device hosting the disc transport unit 140 may access that database to search for files or media in the disc transport unit 140. Changes made to the database while the disc transport unit 140 is in a foreign or visitor host device (such as someone else's carousel 110 or portable player 130) may be uploaded to the home system 100 upon return.

Devices that may have interfaces or ports 135 to access discs stored in the disc transport unit 140 (either by an electronic connection or by a physical transfer of the disc) include the controller 105, the carousel 110, the portable player 130 and game devices described below. In some embodiments, disc transport units 140 may carry one or more hard drives or flash media instead of, or in addition to, discs or other physical media.

In some embodiments, devices such as televisions 120 or stand-alone DVD or CD players, cable or satellite receivers, or sound systems, may be controlled with an infrared control adapter module 145 (which may be nicknamed “IR CAM”). The IR CAM 145 receives a command signal input and translates the command signal input to an output of appropriate infrared or other signals (using an infrared emitter or other suitable emitter) to control the device via an infrared or other signal receiver in the device. In some embodiments, the IR CAM 145 may receive its command signal input from a remote control 115, or a controller 105, or another device in the system 100. The controller 105 or other device providing the command signal input may store translation tables to translate command signals between formats for the IR CAM 145, which may only need to convert the command signal to infrared or another suitable command format for the device being controlled. For example, the remote control 115 may transmit a command to the controller 105, which uses the translation table to convert the command into a suitable pattern to send to the IR CAM 145, which emits the command pattern in infrared. The translation table may include manufacturer-specific data to convert commands (such as play or volume up) between formats to allow a remote control 115 or other device to control several types and makes of devices. The IR CAM 145 may optionally have an optical sensor to detect the presence or color of a power light of the device being controlled, to determine a power status or other status of the device. For example, the IR CAM 145 may transmit a signal to the controller 105 indicating whether the device is turned on or off, based on the power light.

In some embodiments, a mini controller or micro controller 150 may be included in the system 100. A mini or micro controller 150 may be a smaller version of the controller 105, with the same or different features as the controller 105. In some embodiments, mini or micro controllers 150 expand the range of a controller 105 by functioning as a repeater for the input and output signals for the controller 105. In some embodiments, the mini or micro controller 150 may link with the controller 105 to pass control and media data to devices such as a television 120, enabling control of the devices. In some embodiments, a mini or micro controller 150 may be connected to a light switch 155 or a power outlet 160 to enable remote or scheduled (timed) operation of the light switch 155 or the power outlet 160 (for example, power to a coffee pot may be controlled or timed remotely). In an exemplary embodiment, a remote control 115 may be used to program a timer on the controller 105, which may issue commands to the mini or micro controller 150, the light switch 155, or the power outlet 160 to operate those devices. Mini controllers may be generally similar to micro controllers (for example, both mini and micro controllers may have hardwired data ports), but there may be some differences. For example, a mini controller may have one or more power outlets for remote or scheduled (timed) control of devices plugged into the power outlets.

The system 100 may further include a music component 165 (which may be nicknamed a “music port”). The music component 165 may include a CD player, a radio receiver, an internet radio streaming system, or another suitable audio or music source. A speaker system 125 may be connected to or integral with the music component 165 for playback of the music or audio from the music component 165, or the music component 165 may have an output jack or interface for connecting to other playback devices. In some embodiments, the music component 165 may access media stored on the carousel 110 via the controller 105, which may stream or otherwise transmit media to the music component 165 for playback through the speaker system 125 or other output device.

In some embodiments, a personal computer or CPU 170 may be included in the system 100. The computer or CPU 170 may function similarly to the remote control 115, as the controller 105, or as an access point to access media stored in the carousel 110, for example. A printer 175 may be connected to the personal computer or CPU 170 to perform various print activities. For example, a user may access a database of media stored on the controller 105 to print the database or parts thereof. In some embodiments, the computer or CPU 170 may control the controller 105 to activate the controller 105, perform initial setup, create or modify user accounts or permissions (such a parental controls), or other functions.

In some embodiments, one or more (such as most or all) of the devices within the system 100, including the controller(s) 105, the CPU(s) 170, the carousel(s) 110, the remote control(s) 115, the portable player(s) 130, the music component(s) 165, the light switches 155, the power outlets 160, the mini or micro controllers 150, or any other device linked into or controllable within the system 100, may be connected to communicate with each other and the controller 105 via wireless signals, such as Wi-Fi® (including any IEEE 802.11 standard), Bluetooth®, other radio frequency-based communication protocols, or other wireless networking protocols or signals. For example, in some embodiments, one or more wireless networking systems 180 (such as network adapters including, for example, transceivers and antennas) may be included in each device in the system 100.

In some embodiments, one or more (such as most or all) of the devices within the system 100 may be linked or networked with each other using wired connections. Such wired connections may include Ethernet (via category 5, 6, or 7 cables, for example), Universal Serial Bus (USB™), fiber optic cables, or other suitable wired networking protocols. For audio or video transmission, any suitable audio or video transmission protocol may be used, such as HDMI®, DVI, DisplayPort™, VGA, RCA-style cables, coaxial cables, USB™, Bluetooth®, or other protocols or types of cables or wireless networking. In some embodiments, devices may be programmed and linked using a wired connection and then disconnected from the wired connection to participate in the wireless network of the system 100. In some embodiments, use of a wired connection between two or more devices may automatically disable wireless networking equipment for those devices.

Communication between devices in the system 100 may be encrypted. For example, when devices are introduced to the system 100 they may exchange keys or other identifiers to verify their identities and establish an encrypted communication channel. In some embodiments, a hardwired connection, such as a USB™ connection, may be used to introduce new components to the system 100. For example, components may be connected to a remote control 115 via USB™ connection for initial introduction to a system 100. In some embodiments, a display on the controller 105, the television 120, the remote control 115, or another device, may show an on-screen discovery guide or program to guide a user through setup of each device.

In some embodiments, video may be transmitted wirelessly within the system 100. For example, a wireless video adapter 185 may be connected to a television 120 or other display to receive a wireless video broadcast (for example, from the controller 105, which may broadcast wireless video signals) for display to a user. In other embodiments, a coaxial or other wired cable arrangement may transmit video between the controller 105 and the television 120 or other display.

In some embodiments of the present technology, the system 100 may be connected to the world wide web (internet). For example, the controller 105 may include a hub or router to link the system 100 devices to the internet via a cable, satellite, digital subscriber line (DSL), cellular data connection, or other suitable internet connection. When connected to the internet (or in some embodiments, an intranet), the system 100 may be remotely controlled or remotely accessed. For example, a user may access the system 100 through an internet browser or application from any suitable computer terminal, cellphone, or other remote device or portable device 190. Accordingly, in some embodiments, a user may access media within the system 100 from anywhere their remote or portable device 190 has sufficient internet access. A user may adjust the system 100 (for example, turn devices on or off, or adjust user accounts) or command any other task.

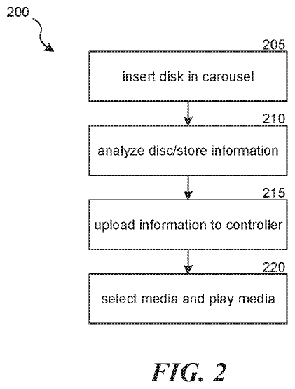

In operation, the system 100 facilitates several media storage and retrieval processes. FIG. 2, for example, illustrates a flow diagram of an example media storage and retrieval process 200 using the system 100 of FIG. 1 in accordance with an embodiment of the present technology. Beginning at block 205, for example, a user may insert a disc into the carousel 110. The carousel 110 may have a door or slot for a user to provide the disc into the carousel 110, which may secure the discs in a mechanism that resists accidental release of the discs, such as when moving the carousel 110 or if the carousel 110 is accidentally jostled.

At block 210, the carousel 110 analyzes the disc to determine one or more pieces of information about the disc, such as the type of file or content (for example, audio or video or other content), genre (for example, country or action or other genres), rating (for example, mature, PG-13, or other ratings), title, artist, or other information about the disc and its content. The carousel 110 stores the pieces of information in a database, along with information about other discs or media. If there are multiple carousels 110 in the system 100, each carousel 110 may store its own database. In some embodiments, if a disc or other media is duplicative of existing media, the carousel 110 may record an indicator of the duplication in the database and alert the user.

The carousel 110 and the controller 105 communicate with each other, such that at block 215, the carousel 110 may upload the information to the controller 105, which creates and maintains a combined database of what is stored or otherwise available across the whole system 100, such as in one or more carousels 110 or in a portable player or visitor port 130, or in another device in the system 100.

In some embodiments, the controller 105 also monitors the presence or absence of system 100 components, or the capacity of system components, such as the capacity or available space of a carousel 110. For example, in some embodiments, upon receipt of a disc transport unit 140 in a carousel 110, the controller 105 may ask the user if the user wants to store the discs in a selected carousel 110 (if there are multiple carousels 110) or whether the user wants the controller 105 to select a carousel 110. If the user commands the controller 105 to select a carousel 110, the controller 105 may select a carousel 110 with the most available space (least used space) and instruct a user to move the disc transport unit 140 to that carousel 110, so the disc can be transferred from the disc transport unit 140 to that selected carousel 110.

At block 220, a user may operate the controller 105 (for example, using the remote control 115), to operate one or more menus or search engines in the controller 105 (via a display on the television 120 or on the display of the remote control 115, for example) to locate and select media for playback on one or more of the devices in the system 100. Upon selection, the controller 105 downloads or streams a copy of the media from the carousel 110 (which may play a disc in its own internal player to generate the copy of the data) and transmits it to a desired playback device (which may also be selected by operating the controller 105), such as a television 120 for playback. The controller 105 may track the number of plays or other information about the use of the selected media in the combined database.

In some embodiments, the controller 105 may store a plurality of copies of movies, audio files, or other files after copying them from the physical media stored in the carousel 110 to enable faster access to the media, or the controller 105 may facilitate a real-time stream from the disc or other media being read in the carousel 110 to the playback device. A user may be given the option to delete the copies stored on the carousel 110. The controller 105 may function as a buffer or server for the media from the carousel 110, or in some embodiments, the controller 105 may direct the carousel 110 to send the media (as a stream, as a full file, or as another format) directly to the playback device.

A controller 105 may turn on all required devices in response to a command to play media, for example, it may turn on the television 120 and a speaker system 125 in response to a request to play a movie. The controller 105 may also turn off all devices with a single command. For example, the controller 105 may respond to the press of an “all off” button (on the controller 105, the remote control 115, or another device) by turning off one or more designated devices in the system 100 (such as all the devices).

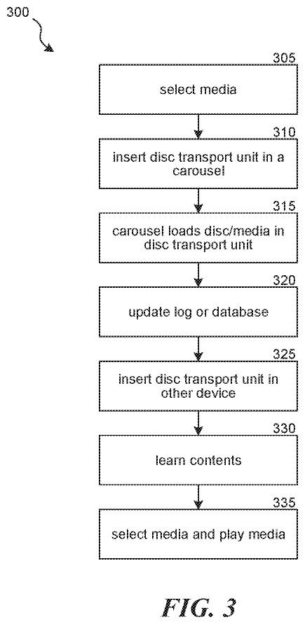

FIG. 3 illustrates a flow diagram of a media storage and retrieval process 300 configured in accordance with another embodiment of the present technology. The process 300 may be used, for example, to transport media for travel or for visiting another system, or for other suitable purposes. Beginning at block 305, a user selects a disc or other media format for retrieval. For example, a user may navigate menus on a display on the controller 105, on the television 120 (provided by the controller 105), or on the remote control 115, to select a media item. At block 310, a user may insert a disc transport unit 140 into a carousel 110. At block 315, the controller 105 instructs the carousel 110 to load the disc or other media item into the disc transport unit 140. In some embodiments, this may involve physically transferring a disc into the disc transport unit 140 or digitally uploading a file to the disc transport unit 140. In some embodiments, a user may initiate a transfer of media from the carousel 110 to the disc transport unit 140 with a switch or command on the carousel 110 itself, rather than via commands from the controller 105 or the remote control 115.

At block 320, one or more databases or logs, such as databases described above, records a notice or status that the media is in the disc transport unit 140 rather than in the carousel 110, so that a user may keep track of the location of the media. For example, in response to a user's later request for the media item, the controller 105 may output an indication that the media item is in the disc transport unit 140 and not available to be requested for playback until it is returned to the carousel 110.

At block 325, a user may bring the disc transport unit 140 to another device, such as a portable player 130, another carousel 110, or another controller 105, each of which may receive the disc transport unit 140 in the disc transport port 135. In some embodiments, these other devices are part of a user's home system 100, or part of another system where the user may be visiting. At block 330, when the portable player 130, the other carousel 110, or other controller 105 receives the disc transport unit 140, it reads the onboard memory of the disc transport unit 140 to learn the contents.

At block 335, a user may access the contents of the disc transport unit 140 via the portable player 130, carousel 110, or controller 105 by interacting with these devices to select media and command play of the media via suitable menus or other controls, similar to the process 200 described above with reference to FIG. 2. In some embodiments, the devices may mechanically retrieve a disc or media item from the disc transport unit 140 and transfer the disc or media item into the device for playback. As described in detail below, a user's ability to play a selected item may be subject to permissions or controls in the devices or a user's own access restrictions, which may be saved in the disc transport unit 140 for the new host devices to access and use. Each of the portable player 130, carousel 110, or controller 105 may update information stored in the memory of the disc transport unit 140, such as the number of plays of the media.

In some embodiments, if the disc transport unit 140 is foreign to a system, such as when a user is visiting with his or her own disc transport unit 140, the controller 105 or carousel 110 may deny passage of the discs from the disc transport unit 140 into the controller 105 or carousel 110. In such embodiments, a visiting user may insert the disc transport unit 140 into the portable player 130, and connect the portable player 130 to the foreign or visited system for playback (wirelessly or with a wired connection).

When a user wants to remove the media from the portable player 130, carousel 110, or controller 105 (for example, when the controller 105 is a combination device and includes a carousel 110), the devices may respond to a command to eject the media or otherwise transfer the media back into the disc transport unit 140 for the user to take to another system or back to the user's home system. At home, the home carousel 110 may retrieve the media from the disc transport unit 140 upon receiving the disc transport unit 140 in the disc transport port 135. In some embodiments, the controller 105 searches its own database to determine whether a media item (such as a disc) has been in the system before, and if so, the controller updates the database to indicate that the media item is back home.

For ease of description, a system that is not a user's home system may be referred to as a host system. When a disc transport unit 140 is visiting and received in a host system, the controller 105 of the host system may invoke a visitor account that provides features specific to visitor activities. Such features may include enablement or disablement of certain account permissions or access to specified playback devices. For example, in some embodiments, visitors may be limited to certain parental control restrictions, or the host system may be prevented from accessing the visitor's media without using the visitor account.

The process 300 illustrated in FIG. 3 may be carried out at any suitable time, for example immediately after blocks 205 or 210 in FIG. 2, or another time. The processes 200, 300 provide a user with automatic tracking of the location of their media while protecting the physical media itself by maintaining it in the disc transport unit 140.

In some embodiments, when a disc transport unit 140 is inserted into a disc transport port 135, the device with the disc transport port 135 (such as a carousel 110) may execute multiple operations, depending on the quantity and type of discs or other media items in the disc transport unit 140.

For example, if the disc transport unit 140 is empty, the controller 105 may ask (via menus or requests in the user interface on a display) if the user wants to load discs into the disc transport unit 140. If the disc transport unit 140 is not recognized as part of the home system 100, the controller 105 may ask if the user is a visitor, and if yes, the controller 105 may invoke and present a visitor account. If the disc transport unit 140 is not full and the controller 105 recognizes the discs as being part of the home system 100, the controller 105 may ask if the user wants to select more discs for loading or the user wants to reinstall the discs into a carousel 110. If the disc transport unit 140 is full and there is a mix of new and recognized discs, the controller 105 may ask if the user wants to reinstall system discs and add the new discs. If the disc transport unit 140 is full of discs recognized to be part of the user's home system 100, the controller 105 may ask if the user wants to reinstall the discs in a carousel 110. If the disc transport unit 140 is neither a part of the user's home system 100 nor a visitor's disc transport unit 140, the controller 105 may ask if a user wants to install the discs into the system 100 (via the carousel 105, for example). In any of the foregoing examples, the controller 105 and the carousel 110 execute appropriate instructions and mechanical actions to install or add discs, such as instructions, actions, or processes described herein.

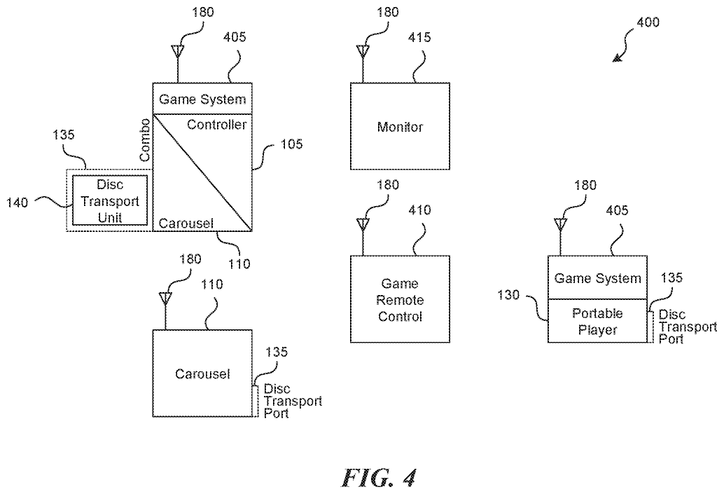

FIG. 4 illustrates a system 400 configured in accordance with another embodiment of the present technology. The system 400 in FIG. 4 may be generally similar to the system 100 in FIG. 1, but with a different number and arrangement of participating devices. For example, the system 400 in FIG. 4 may be oriented toward video games. In some embodiments, a game system 405 may be connected to or integral with the controller 105. The game system 405 may include any suitable game console, such as an Xbox®, PlayStation®, or other past, present, or future game console or game system.

The controller 105 may be attached to or integral with the carousel 110 (forming a combination or combo device). The controller 105 (with or without an integral carousel 110) may be nicknamed a “game tower.” Disc transport unit 140 may be received in the disc transport port 135 of the carousel 110. The game system 405 may be controlled and operated similarly to other devices in the system 400 (or the system 100 described above). For example, upon receiving a request (by a remote control or other device) to select and play a video game, the controller 105 may provide a display of available games a user may select. Upon selection, the controller 105 may instruct the carousel 110 to transmit data corresponding to the selected game to the game system 405, for the game system 405 to play the game (for example, on a monitor 415).

In some embodiments, a game remote control 410 may receive commands from a user. The game remote control 410 may be similar to the remote control 115 illustrated in FIG. 1 and described above. It may have additional or different controls than the remote control 115 for controlling video games. For example, the game remote control 410 may have buttons that provide specific commands to the game system 405 (such as directional controls, A, B, X, Y, L, R, or other buttons understood to be associated with video games). The game remote control 410 may command the controller 105 to power the game system 405 and provide a video game to the game system 405 from a disc stored in the carousel 110, for example, based on a user's selection of the game via on-screen menus.

In the system 400, a user may load and access games (on discs or other media) for playback in the game system 405 similar to loading and accessing other media on discs as described above with regard to FIGS. 1-3. In some embodiments, the game system 405 may control the combination controller 105 and carousel 110 to retrieve games for play (rather than the controller 105 instructing and controlling the controller 105).

A monitor 415 may receive video or audio signals from the game system 405 or controller 105 for a viewer to observe the game and feedback from controls received by the game remote control 410. In some embodiments, portable player 130 may be connected to a game system 405 for portable gameplay using games from the disc transport unit 140 connected to the system 100 via the disc transport port 135. When the portable player 130 is configured for video games or for connection to a game system 405, it may be nicknamed a “game keep.”

In some embodiments, the game system 405 may be partially or fully restricted from interacting with the controller 105. For example, to preserve intellectual property rights of video game system manufacturers (software, copyright, etc.), the game system 405 may be restricted or prevented from exchanging game or other data with the controller 105, with an exception of an “all off” command or other power commands from the controller 105. In such embodiments, the game system 405 may exchange software or game data with only the carousel 110, which may store games for multiple different game systems 405, or a single game system 405 capable of reading and running game data associated with multiple different game platforms.

Systems according to embodiments of the present technology are modular and scalable. For example, any suitable number or type of components or playback devices can be introduced to, used in, and controlled within the systems. In a particular example, the controller 105 may be in a family room, while the music component 165 may be in a garage, and the carousel 110 may be in a closet. The remote control 115 may receive command inputs from a user to play a song on the music component 165. The remote control 115 may transmit the command to the controller 105, which may command the carousel 110 to retrieve the disc or other media item holding the selected song and transmit the requested media item from the carousel 110 to the music component 165 for playback (optionally, via the controller 105). A similar example may involve a DVD player, a movie, and a television located in different rooms. Devices may be added or removed from the system at any time, and the controller 105 is configured to track such additions or removals.

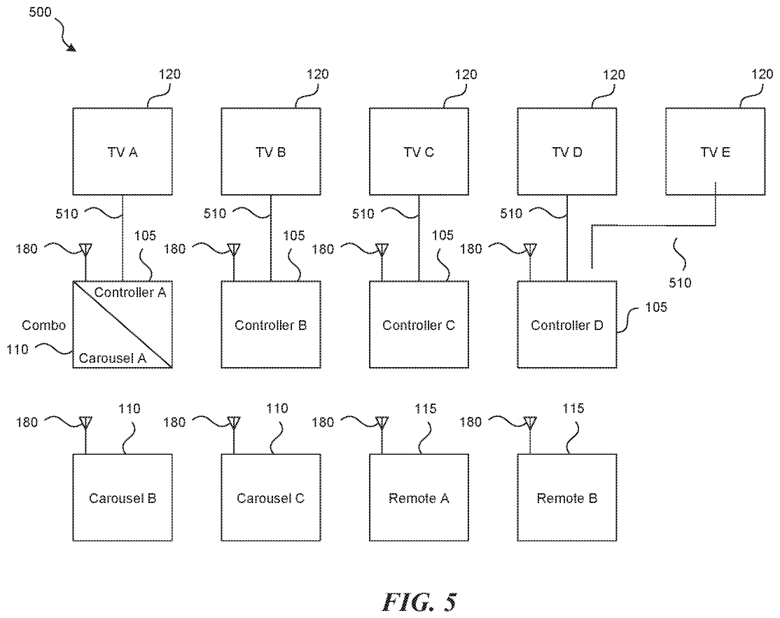

FIG. 5 illustrates a system 500 configured in accordance with yet another embodiment of the present technology to further illustrate the modularity and scalability of the present technology. The system 500 in FIG. 5 may be generally similar to the systems 100, 400 described above with regard to FIGS. 1 and 4, but with a different number and arrangement of devices. For example, the system 500 may include more than one controller 105 (or more than one combination of controller 105 and carousel 110). Each controller 105 may be connected to a display, monitor, or television 120. In some embodiments, the controller 105 may be connected to more than one television 120 (illustrated as Controller D connected to TV D and TV E). Although a hardwired connection 510 is illustrated, a wireless video connection may transmit video and command signals between the controllers 105 and the televisions 120, as described above. Each of a plurality of remote controls 115 may control one or more (such as all) of the controllers 105. The system 500 may include one or more game systems 405 (see FIG. 4), computers 170 (see FIG. 1), light switches 155 (see FIG. 1), or any other device described herein, or other suitable devices.

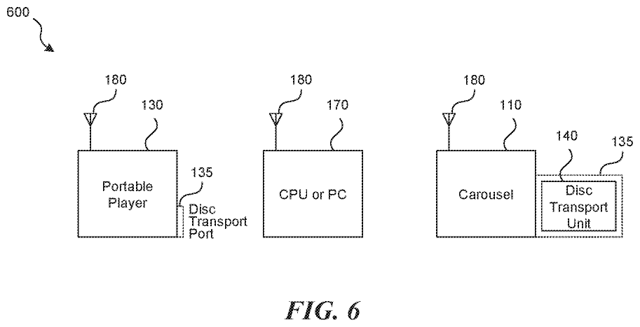

FIG. 6 illustrates a system 600 with a carousel 110 functioning as a fileserver for recordkeeping or records access and configured in accordance with another embodiment of the present technology. In some embodiments, discs or other physical media (or virtual media such as media stored in flash drives), may store documents such as personal files for individuals and families, or business or government files or records. Systems according to embodiments of the present technology provide streamlined and organized access to these files and records. The files may be accessed and transported similarly to processes described above for movies and songs (DVDs and CDs).

In some embodiments, large quantities of records may be scanned or otherwise put into a media format, such as on a disc, hard drive, or other media. The media may be put into a carousel 110 (such as on a plurality of discs in the carousel 110), and a storage and retrieval process similar to the storage and retrieval process 200 described above with regard to FIGS. 2 and 3 may be executed by the system.

For example, the carousel 110 may read the files on the media (such as a DVD) and automatically (or with manual assistance from a user) create a database of what is on the media, such as the name of a file, the date it was created or modified, the author, keywords about the content, full text of the content, or other identifying information or substantive information. The carousel 110 or a computer 170 may maintain a database of all the identifying or substantive information stored within the carousel 110, such as which disc the information is on. A user may search the database using the computer 170, which may request the carousel 110 load the disc or other media with the file corresponding to the search results, and the computer 170 may then receive the file from the carousel 110 for display to the user.

In some embodiments, groups of discs with such files or records may be loaded into the disc transport unit 140, for use in the portable player 130, similar to the process described above with regard to FIG. 3.

In an example, a real estate agent may need to locate an old document she knows to be stored on a disc in her carousel. She may access a menu or user interface on the personal computer 170 to enter search criteria about the document, such as the date and the parties associated with the document. The personal computer 170, knowing which disc the file is on in the carousel by way of the database, requests that the carousel 110 retrieve the disc and transmit the document to the personal computer 170 for review.

In some embodiments, the system 600 facilitates remote access to files on discs in the carousel 110, similar to the remote access described above with regard to FIG. 1 (using a portable device 190 such as a mobile phone or tablet). The system 600 may facilitate access to personal files in a home setting or it can be used in a business or government setting. In some embodiments, the computer 170 may back-up its data to discs or other media such as hard drives or flash media in the carousel 110 by transmitting data to the carousel 110 for the carousel 110 to burn or write the media. The system 600 in FIG. 6 is illustrated without controller 105, but the present technology also contemplates embodiments in which the system 600 is part of another system described herein, or it may further include controller(s) 105 or other devices.

The modularity, scalability, and networked architecture of systems embodying the present technology allow users to place various components described herein (such as televisions 120, game systems 405, carousels 110, computers 170, music components 165) or other multimedia or document processing components in different rooms or buildings. System administrators may decide that access to some or all elements or devices of the system should be restricted from certain people, such as visitors or children, especially when some elements or devices of the system are located in a child's room or are otherwise accessible to children. Embodiments of the present technology include access control, such as password control or account management) and parental controls.

Upon initial setup (such as when a system is first implemented), the controller 105 may carry out an on-screen setup routine to allow a user to select a quantity of desired accounts, the types of devices in the system and the types of devices allowed to be used by an account, content restrictions for certain accounts, and time restrictions, for example.

The controller 105 may also be configured to assist with maintaining a database of user accounts. A system administrator may set access rights and limitations for the accounts. For example, a parental account may have full access to all devices, all media, all ratings of programming available within the system, at any time of day. A child's account may have limited access. For example, a child's account may only be able to access specified types of media (such as children's shows or PG-rated movies, or kid-friendly music) or the child's account may not be allowed to access any media during a certain time (such as bedtime). A visitor account's settings may specify that visitors (who may bring their own disc transport unit 140) have the same or more limitations as they would in their home system (such settings are stored in onboard memory in the disc transport unit 140).

All accounts may be password protected and require login credentials. Optionally, the system may allow access to some media or devices without an account or login credentials, or a particular account may lack a password requirement and may allow access to certain media or devices (which may be nicknamed an “all view” account). The controller 105 contains a processor and memory to carry out the operations described herein, including parental control rules, to enable or disable access to media or devices depending on account permissions or time constraints.

In some embodiments, a visitor may trigger the creation of a visitor account by putting a disc transport unit 140 into a disc transport port 135. The controller 105 may invoke a menu, user interface, or process to create a visitor account after receiving a signal that a disc transport unit 140 has been installed in a disc transport port 135 somewhere in the system.

Processes of loading media into the carousel 110 for introduction into a system are described above with regard to FIGS. 2 and 3. In some embodiments, processes for introducing and loading media (such as discs, digital music, or other media) into a system may include analyzing the media for content ratings and restrictions. For example, the carousel 110 (with or without assistance from the controller 105) may determine the rating of the content (such as G, PG, mature, or otherwise) and record the rating in the system databases. If the rating does not correspond with a user's account permissions, the controller 105 will not play the content. Accordingly, the system automatically limits user access to some new and existing content the moment it is introduced into the system.

In some embodiments, the controller 105 or carousel 110 may not recognize media. In such cases, the controller 105 may instruct the carousel 110 to hold the media in a holding file or holding zone. The holding zone may be a physical area within the carousel 110, or the holding zone may be implemented by the controller 105 or carousel 110 logging in the database that the media should be in holding. In some embodiments, a disc cannot be removed from holding until a system administrator or other account with suitable permissions assigns an identity or rating to the media. In some embodiments, the controller 105 may automatically assign an identity or rating to the media.

In general, the controller 105 includes a memory, processor, and input/output devices for a user to customize access control for each user account and to customize what the system does when new media is added. In some embodiments, the controller 105 may include a media player, such as a CD player, DVD player, or a cassette player (such as an audio cassette or a VHS cassette).

In some embodiments, the remote control 115 or television 120 may display what another account is viewing, and the remote control 115 may allow modification of devices that another account is viewing. For example, a parent may view what a child's account is viewing and make changes, optionally without any on-screen indication to the child that a parent is observing or making changes.

The controller 105 may be further configured to lock user accounts or lock users from accessing certain media or devices if a user attempts to use a device in violation of the permissions assigned to the user's account. For example, at bedtime, the controller may send a signal to a television to instruct the television to turn off. If a user attempts to turn the television back on one or more times, the attempts may be logged and the user's account may be locked. As a further example, if media with a higher rating than is authorized for a particular account is inserted into the media player in the controller 105, the controller 105 may prevent the media from playing, it may prompt the user to select and log into an account with appropriate permissions, or it may capture or seize the media item and deny release or ejection until a user with appropriate permissions commands the release or ejection. The controller 105 may log other activities or lock accounts for performing certain activities, such as hacking attempts or attempts to bypass other parental controls.

In some embodiments, the controller 105 includes a clock or timer for scheduling of parental control or access control features described above. In further embodiments, the timer facilitates a vacation mode in which devices are operated to appear as though the users are home. For example, the controller 105 may receive commands to designate scheduling for turning devices on or off or playing certain media or devices at set times, random times, or quasi-random times. Quasi-random times may involve a set schedule except that the controller 105 may stagger or vary the programmed start or stop times to avoid the appearance of an exact routine. In some embodiments, the controller 105 may operate the television 120, devices plugged into the electric outlet 160, light switch 155, music component 165, or any other present or future device capable of being operated with the controller 105.

In some embodiments, the vacation mode of the controller 105 may, in response to receiving a user command to do so, operate a sequence of lighting (using light switches 155, for example) that simulates a user's presence in the home. For example, lights may be turned on and off in sequence through various rooms to simulate movement from room to room.

In yet further embodiments, the timer in the controller 105 includes a sleep mode to turn off devices after a selected amount of time, to allow a user to fall asleep without worrying about needing to turn off the selected devices.

Embodiments of the present technology facilitate placement of various devices or components of systems described herein in various rooms while providing access to the devices and media stored therein, depending on the locations of controllers 105, televisions 120, music components 165, and other devices. Numerous various combinations and arrangements of systems are contemplated by embodiments of the present technology.

Advantages of embodiments of the present technology also include providing a centralized, organized, and convenient management of various types of digital and physical media, to facilitate improved access to media via several convenient or portable sources. For example, a user who may previously have been frustrated with organization and handling of fragile discs will find that the present technology reduces the risk of damaging a disc and automatically organizes the user's collection of discs and other media. Controllers according to the present technology operate multiple devices, so a single command to play a media item may be facilitated by the controller turning on the appropriate device (a TV or speaker system, for example) and accessing the media item (from the carousel, or from a cable box, for example).

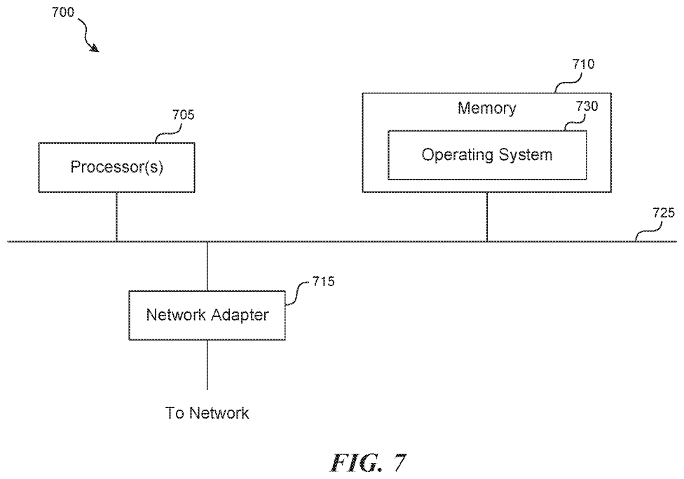

FIG. 7 is a block diagram illustrating an example of the architecture for a computer system or other control device 700 that can be utilized to implement various portions of the present technology. In FIG. 7, the computer system 700 (which may be or may include the controller 105, the carousel 110, the remote control 115, the portable player 130, the IR CAM 145, the micro controller 150, the computer 170, the portable device 190, and/or other computers, controlling devices, or components in accordance with embodiments of the present technology) includes one or more processors 705 and memory 710 connected via an interconnect 725. The interconnect 725 may represent any one or more separate physical buses, point to point connections, or both, connected by appropriate bridges, adapters, or controllers. The interconnect 725, therefore, may include, for example, a system bus, a Peripheral Component Interconnect (PCI) bus, a HyperTransport or industry standard architecture (ISA) bus, a small computer system interface (SCSI) bus, a universal serial bus (USB), IIC (I2C) bus, or an Institute of Electrical and Electronics Engineers (IEEE) standard 674 bus, sometimes referred to as “Firewire”. The interconnect 725 may include any other interconnect suitable for connecting components and transmitting signals, including other connections disclosed herein.

The processor(s) 705 may include central processing units (CPUs) to control the overall operation of, for example, the host computer. In certain embodiments, the processor(s) 705 accomplish this by executing software or firmware stored in memory 710. The processor(s) 705 may be, or may include, one or more programmable general-purpose or special-purpose microprocessors, digital signal processors (DSPs), programmable controllers, application specific integrated circuits (ASICs), programmable logic devices (PLDs), or the like, or a combination of such devices.

The memory 710 can be or include the main memory of the computer system. The memory 710 represents any suitable form of random access memory (RAM), read-only memory (ROM), flash memory, or the like, or a combination of such devices. In use, the memory 710 may contain, among other things, a set of machine instructions which, when executed by processor 705, causes the processor 705 to perform operations to implement embodiments of the present invention.

Also connected to the processor(s) 705 through the interconnect 725 is a (optional) network adapter 715 (which may be or may include the wireless networking systems 180 or wired systems). The network adapter 715 provides the computer system 700 with the ability to communicate with remote devices, such as storage clients, and/or other storage servers, and may be, for example, an Ethernet adapter or Fiber Channel adapter, or adapters for other communication protocols disclosed herein.

The techniques introduced herein can be implemented by, for example, programmable circuitry (e.g., one or more microprocessors) programmed with software and/or firmware, or entirely in special-purpose hardwired circuitry, or in a combination of such forms. Special-purpose hardwired circuitry may be in the form of, for example, one or more application-specific integrated circuits (ASICs), programmable logic devices (PLDs), field-programmable gate arrays (FPGAs), etc.

Software or firmware for use in implementing the techniques introduced here may be stored on a machine-readable storage medium and may be executed by one or more general-purpose or special-purpose programmable microprocessors. A “machine-readable storage medium,” as the term is used herein, includes any mechanism that can store information in a form accessible by a machine (a machine may be, for example, a computer, network device, cellular phone, personal digital assistant (PDA), manufacturing tool, any device with one or more processors, etc.). For example, a machine-accessible storage medium includes recordable/non-recordable media (e.g., read-only memory (ROM); random access memory (RAM); magnetic disk storage media; optical storage media; flash memory devices; etc.), etc.

The term “logic,” as used herein, can include, for example, programmable circuitry programmed with specific software and/or firmware, special-purpose hardwired circuitry, or a combination thereof.

### B. ADDITIONAL EXAMPLES

The following examples provide additional embodiments of the technology.

1. A system for media storage and retrieval, the system comprising:
a controller configured to receive first commands, transmit second commands to a mass storage device, receive first signals corresponding to audio, video, or document data from the mass storage device, and transmit second signals corresponding to the first signals; and
a display device or audio device configured to receive the second signals and reproduce the audio, video, or document data for observation by a user;
wherein the mass storage device comprises a mechanism configured to store, retrieve, and play one or more of a plurality of discs containing the audio, video, or document data, and the mass storage device is configured to transmit the audio, video, or document data to the controller using the first signals.

2. A system for media storage and retrieval, the system comprising:
a controller configured to receive first commands, transmit second commands to a mass storage device, receive first signals corresponding to audio, video, or document data from the mass storage device, and transmit second signals corresponding to the first signals;
a display device or audio device configured to receive the second signals and reproduce the audio, video, or document data for observation by a user.

3. The system of example 2, further comprising a remote control configured to send the first commands to the controller.

4. The system of example 2 or 3 wherein the controller is a first controller, and wherein the system further comprises a second controller configured to receive third commands from the remote control.

5. The system of any one of examples 2-4 wherein the mass storage device is a first mass storage device, and the system further comprises a second mass storage device configured to receive third commands from the controller and transmit second signals corresponding to audio, video, or document data to the controller.

6. The system of any one of examples 2-5 wherein the mass storage device comprises a mechanism configured to store, retrieve, and play one or more of a plurality of discs, and the mass storage device is configured to transmit first data using the first signals to the controller.

7. The system of any one of examples 2-6, further comprising a disc transport unit, wherein the disc transport unit is removable and replaceable from the mass storage device.

8. The system of any one of examples 2-7 wherein the display device is a television configured to communicate with the controller via a wireless connection.

9. The system of any one of examples 2-8 wherein the audio device communicates with the controller via a wireless connection.

10. The system of any one of examples 2-9, further comprising a light switch configured to communicate with the controller via a wireless connection.

11. The system of any one of examples 2-10, further comprising a video game console configured to receive commands from the controller.

12. A method for storing and retrieving media for playback, the method comprising:
receiving a media item in a mass storage device;
analyzing the media item to determine one or more pieces of information about the media item;
storing the one or more pieces of information in a first database in the mass storage device;
transmitting the first database to a controller;
creating, with the controller, a second database that includes the first database;
displaying a piece of information in the second database;
receiving, based on the piece of information, a command to play the media item; and
transmitting a signal corresponding to the media item to a playback device configured to play the signal.

13. The method of example 12 wherein the media item is a disc.

14. The method of example 12 or 13 wherein the playback device is a television or a speaker system.

15. The method of any one of examples 12-14 wherein the mass storage device analyzes the media item.

16. The method of any one of examples 12-15 wherein the one or more pieces of information comprises a type of file, a genre, a rating, an artist, or a title.

17. The method of any one of examples 12-16 wherein the mass storage device is a first mass storage device, and wherein the second database includes location information corresponding to a location of a second media item in one or more second mass storage devices.

18. The method of any one of examples 12-17, further comprising storing a copy of the media item on the controller.

19. The method of any one of examples 12-18, further comprising controlling a power status of the playback device using the controller, wherein the power status comprises an on status or an off status.

20. A method for storing and retrieving media for playback, the method comprising:
receiving, by a controller, a selection of a media item;
receiving, by a mass storage device, a disc transport unit;
loading a disc containing the media item into the transport unit;
receiving, by a second device, the disc transport unit;
loading the disc into the second device; and
playing audio or video from the disc on a playback device via the second device.

21. The method of example 20 wherein receiving a selection of a media item comprises providing a menu on a display and receiving the selection from a user.

22. The method of example 20 or 21, further comprising recording, in a database, an indicator of the step of loading the media item into the transport unit.

23. The method of any one of examples 20-22, further comprising loading parental control restrictions corresponding to the media item into the transport unit.

### C. CONCLUSION

From the foregoing, it will be appreciated that specific embodiments of the disclosed technology have been described for purposes of illustration, but that various modifications may be made without deviating from the technology, and elements of certain embodiments may be interchanged with those of other embodiments. For example, although systems and methods or processes may be described herein with regard to discs, in other embodiments, embodiments of the present technology may accommodate other types of physical media, such as audio cassettes, video cassettes (such as VHS-format cassettes), phonograph records, video game cartridges, or any other suitable media format, and embodiments of the present technology may read or write one or more sides of physical media. Embodiments of the present technology may also accommodate other types and formats of virtual media (such as audiovisual files or other files). It is understood that future formats of physical and digital media may also be accommodated by embodiments of the present technology.

In some embodiments, controllers 105 or other devices may have a modular construction, such that components like media players or data transceivers may be added or replaced to upgrade or update the controllers 105 to keep up with or stay ahead of the state of the art. In some embodiments, media players in the controller 105 may record broadcasts or other media based on a timer programmed by a user. Parental control options may limit a user's ability to record. Any steps in processes or methods described herein may optionally be omitted or performed in a different order than described herein.

Further, while advantages associated with certain embodiments of the disclosed technology have been described in the context of those embodiments, other embodiments may also exhibit such advantages, and not all embodiments need necessarily exhibit such advantages to fall within the scope of the technology. Accordingly, the disclosure and associated technology may encompass other embodiments not expressly shown or described herein.

To the extent any materials incorporated herein conflict with the present disclosure, the present disclosure controls.

1. (canceled)

2. A system for media storage and retrieval, the system comprising:
a controller configured to receive first commands, transmit second commands to a mass storage device, receive first signals corresponding to audio, video, or document data from the mass storage device, and transmit second signals corresponding to the first signals;
a display device or audio device configured to receive the second signals and reproduce the audio, video, or document data for observation by a user.

3. The system of claim 2, further comprising a remote control configured to send the first commands to the controller.

4. The system of claim 3 wherein the controller is a first controller, and wherein the system further comprises a second controller configured to receive third commands from the remote control.

5. The system of claim 2 wherein the mass storage device is a first mass storage device, and the system further comprises a second mass storage device configured to receive third commands from the controller and transmit second signals corresponding to audio, video, or document data to the controller.

6. The system of claim 2 wherein the mass storage device comprises a mechanism configured to store, retrieve, and play one or more of a plurality of discs, and the mass storage device is configured to transmit first data using the first signals to the controller.

7. The system of claim 2, further comprising a disc transport unit, wherein the disc transport unit is removable and replaceable from the mass storage device.

8. The system of claim 2 wherein the display device is a television configured to communicate with the controller via a wireless connection.

9. (canceled)

10. The system of claim 2, further comprising a light switch configured to communicate with the controller via a wireless connection.

11. The system of claim 2, further comprising a video game console configured to receive commands from the controller.

12. A method for storing and retrieving media for playback, the method comprising:
receiving a media item in a mass storage device;
analyzing the media item to determine one or more pieces of information about the media item;
storing the one or more pieces of information in a first database in the mass storage device;
transmitting the first database to a controller;
creating, with the controller, a second database that includes the first database;
displaying a piece of information in the second database;
receiving, based on the piece of information, a command to play the media item; and
transmitting a signal corresponding to the media item to a playback device configured to play the signal.

13. The method of claim 12 wherein the media item is a disc.

14. The method of claim 12 wherein the playback device is a television or a speaker system.

15. (canceled)

16. The method of claim 12 wherein the one or more pieces of information comprises a type of file, a genre, a rating, an artist, or a title.

17. The method of claim 12 wherein the mass storage device is a first mass storage device, and wherein the second database includes location information corresponding to a location of a second media item in one or more second mass storage devices.

18. The method of claim 12, further comprising storing a copy of the media item on the controller.

19. The method of claim 12, further comprising controlling a power status of the playback device using the controller, wherein the power status comprises an on status or an off status.

20. A method for storing and retrieving media for playback, the method comprising:
receiving, by a controller, a selection of a media item;
receiving, by a mass storage device, a disc transport unit;
loading a disc containing the media item into the transport unit;
receiving, by a second device, the disc transport unit;
loading the disc into the second device; and
playing audio or video from the disc on a playback device via the second device.

21. The method of claim 20 wherein receiving a selection of a media item comprises providing a menu on a display and receiving the selection from a user.

22. The method of claim 20, further comprising recording, in a database, an indicator of the step of loading the media item into the transport unit.

23. The method of claim 20, further comprising loading parental control restrictions corresponding to the media item into the transport unit.
